(19) United States
(12) Patent Application Publication
(10) Pub. No.: US 2007/0288640 A1
(43) Pub. Date: Dec. 13, 2007

(54) REMOTE RENDERING OF MULTIPLE MOUSE CURSORS

(75) Inventor: Robert Wilhelm Schmieder, Snoqualmie, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/422,874

(22) Filed: Jun. 7, 2006

(51) Int. Cl. G06F 15/16

(52) U.S. Cl. 709/227; 709/231

(57) ABSTRACT

Embodiments provide for a mechanism that extends the protocol of a remote session by enabling clients to simultaneously display multiple cursors, without having to modify data instructions for the protocol. Each viewer will have the ability to control its own mouse pointer, which will not be automatically synchronized in shape and/or position with the sharer's computer. As such, the viewer's user interface will display at least two mouse cursors. The first cursor will be the viewer's cursor; the second cursor is the sharer's cursor (or some other clients mouse pointer), which will typically match the actual position and/or shape of the cursor in the remote session. In order to support legacy clients by not changing the protocol that controls legacy client's cursor position and/or appearance, embodiments render the sharer's cursor (or other pointer as the case may be) as part of the protocol's graphic stream.

### CROSS-REFERENCE TO RELATED APPLICATIONS

N/A

### BACKGROUND

As computerized systems have increased in popularity, so have the needs to distribute files and processing resources of computer systems in networks both large and small. In general, computer systems and related devices communicate information over a network for a variety of reasons, for example, to exchange personal electronic messages, sell merchandise, provide account information, and so on and so forth. One will appreciate, however, that as computer systems and their related applications have become increasingly more sophisticated, the challenges associated with sharing data and resources on a network have also increased.

Some current ways for distributing resources within an organizational network might involve a centralized server or computing system (or local device) sharing resources with one or more clients (or remote devices) that typically do not have such resources installed locally. Such systems normally use a dedicated protocol such as Remote Desktop Protocol (“RDP”), Independent Computing Architecture (ICA), and others, to share various applications with such remote clients. With such protocols, a client computer system can access a centralized network server or computing system, which hosts resources of interest, and interact (e.g., sending mouse and keyboard events, etc.) with those resources just as though those resources were installed locally.

The network server in turn processes those interactions, creates corresponding rendering information of the data, and sends both the processed data and created rendering information back to the client. The client computer system then receives the data and rendering information, and uses a client-side video driver to render and display the received data locally. Ideally, this interaction between the client computer system and network system occurs seamlessly as though the client computer had actually processed the data locally with its own installed resources.

Another type of system that is similar in most respects to the centralized sharing model described above involves a broadcasting (or “sending”) client computer system configured to send window data information to other recipient client computer systems on a network. This feature is also sometimes called “desktop sharing.” In this example, the broadcasting computer (e.g., an “instructor” in a learning environment) and the recipient computer systems (e.g., “students”) connect using a commonly-installed application program that allows for sharing of desktop views and locally installed applications at the instructor computer. Similar to the centralized computing system scenario, the client computer systems might be able to interact with the windows displayed at the instructor computer as though the windows were the student computer's own.

The protocols used in the above remote sessions utilize bitmaps for sharing at least portions of application user interfaces, which are sent across a graphics stream for viewing on the remote device. Because bitmaps are expensive in terms of bandwidth consumption when transmitted over a network connection (e.g., the Internet), rather then sending the entire bitmaps most systems nowadays (such as those described above) send graphic primitives and other operations, which tell a sub-routine on the client side what and how to draw something. For example, a client may be told to draw a rectangle along with information about where it should be drawn, what size, color, etc. For instance, a rectangle may be used to draw a button for a user interface, a border around a document, or any other purpose for which a rectangular shape may be useful. Of course, there are many other shapes and operations that can be used as primitives that may be more sophisticated and require more processing that must be done to transfer and perform the operation on the remote client.

Unlike bitmaps and primitives, however, the remote session protocols mentioned above typically send configuration information (including information about where and how to draw a primitive) as instructional data packets. Such data may control or modify the look and feel of various objects or components on the remote computing device. For example, typical remoting protocols define a single mouse cursor for display during a remote session, which can be modified using data instructions that change the position and/or the appearance of the mouse. As such, the mouse cursor on the remote computing device is synced to the mouse cursor on the local or host computer, thus giving a seamless appearance of a single mouse from the perspective of the host computing system.

In remote desktop scenarios, there is typically only a single user involved in the session—i.e., the user accessing the remote server to connect to resources thereon. The user that connects to the remote computer has full control over the desktop input, including the mouse cursor. In screen sharing/remote assistance scenarios, however, there may be multiple users involved. One of the users is typically referred to as a “sharer” that shares the content of his/her computer desktop; the other user's are know as “viewers” that use the remote client to view the content broadcasted by the sharer. In such case, multiple users typically share the control of the sharer's desktop, each of which can move the sharer's mouse cursor. As mentioned above, however, current remote session protocols (e.g., RDP) only deal with the remote desktop scenario where a remote user controls the remote computer mouse pointer and the mouse pointer for the local user is kept in sync at all times with the remote computer's mouse. As such, these remoting protocols do not support simultaneous display of multiple mouse pointers or cursors on a viewer's display.

### BRIEF SUMMARY

The above-identified deficiencies and drawback of current remoting protocols are overcome through example embodiments of the present invention. For example, embodiments described herein provide for methods, systems, and computer program products for extending the remoting protocol by enabling legacy clients to simultaneously display multiple cursors, without having to modify data instructions for a channel of the protocol that control the legacy client's cursor position and/or appearance. Note that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one example embodiment an application is executed on a local device, which generates a graphics display for rendering it at a viewer's computing device during a remote session that uses a protocol configured to remote the graphics display using a graphics stream. Note that the protocol typically sends changes for the viewer's mouse cursor as data instructions of an update or control packet in order to sync the viewer's mouse cursor and the local device's or sharer's mouse cursor. It is then determined that at least one additional mouse cursor is to be displayed at the viewer's computing device during the remote session. Based on the determination, the graphical representation of the additional mouse cursor is generated and sent over the graphic stream to the viewer's computing device for rendering it as a bitmap. Accordingly, the addition mouse cursor is simultaneously displayed with the viewer's mouse cursor during the remote session.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates distributed system configured to remote mouse cursors using a graphics stream in accordance example embodiments; and

FIG. 2 illustrates a flow diagram for a method of extending a remoting protocol for enabling legacy clients to simultaneously display multiple cursors in accordance example embodiments.

### DETAILED DESCRIPTION

The present invention extends to methods, systems, and computer program products for extending remote session protocols by enabling legacy clients to simultaneously display multiple cursors. The embodiments of the present invention may comprise a special purpose or general-purpose computer including various computer hardware or modules, as discussed in greater detail below.

As previously mentioned, current remote session protocols (e.g., remote desktop protocol (RDP)) modify the position and/or appearance of a mouse cursor on the viewer's display using a mouse cursor update or control packet. More specifically, the remote protocol sends cursor instructions as packet data units (PDUs) for synchronizing both the sharer's and viewer's mouse pointers. In screen sharing or remote assistance scenarios, however, there are multiple users involved; thus generating a need to simultaneously display multiple mouse cursors as they actually appear.

Note that one solution to the above problem might be to modify the remote session protocol to include configuration settings for multiple cursors. Such solution, however, would not work for legacy clients that only have the notion of receiving data instructions for syncing a single mouse cursor. Accordingly, embodiments provide for a mechanism that extends the protocol of a remote session by enabling legacy clients (as well as other clients) to simultaneously display multiple cursors, without having to modify data instructions for the protocol that controls legacy client's cursor position and/or appearance. In such an embodiment, each viewer will have the ability to control its own mouse pointer, which will not be automatically synchronized in shape, size, and/or position with the sharer's computer. As such, the viewer's mouse pointer will be meaningful to that viewer and will be used to track intended modifications for the mouse position. The actual mouse shape, size, and/or position (as appearing from the sharer's or some other remote source) will come from the sharer and can be the result of input coming from multiple users.

In others words, embodiments advantageously provide that the viewer's user interface will display at least two mouse cursors. The first cursor will be the viewer's cursor as described above; the second cursor is the sharer's cursor (or some other clients mouse pointer), which will typically match the actual position and/or shape of the cursor in the remote session. In order to support legacy clients by not changing the underlining remote session protocol (e.g., RDP), embodiments render the sharer's cursor (or other pointer as the case may be) as part of the protocol's graphic stream.

For example, in one embodiment the sharer's cursor is sent to the client as plain or standard bitmap updates (i.e., bitmaps that are not normally cached). Such bitmap representation is the most generic way to send the cursor to the client; at the same time keeping compatibility with older, legacy and/or micro-clients (i.e., clients that support only plain bitmap updates or a very limited set of update types). In such case, however, the cursor is sent in a very insufficient way typically not suitable for slow link connections. Nevertheless, if the client is a micro, such bitmap or screen data updates are typically the only way that the sharer's cursor may be sent, which is typically not a problem considering that most micro-clients are usually designed to run in high bandwidth configurations.

Problems may arise, however, in the screen sharing or remote assistance scenarios where the sharer does not include a high speed connection. In such case, mouse updates may take an unacceptably high amount of bandwidth and the update rate will hurt the user experience. In such situation, embodiments provide a better solution by sending the share's mouse cursor in the form of protocol orders, as will be described in greater detail below.

Although more specific reference to advantageous features are described in greater detail below with regards to the Figures, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

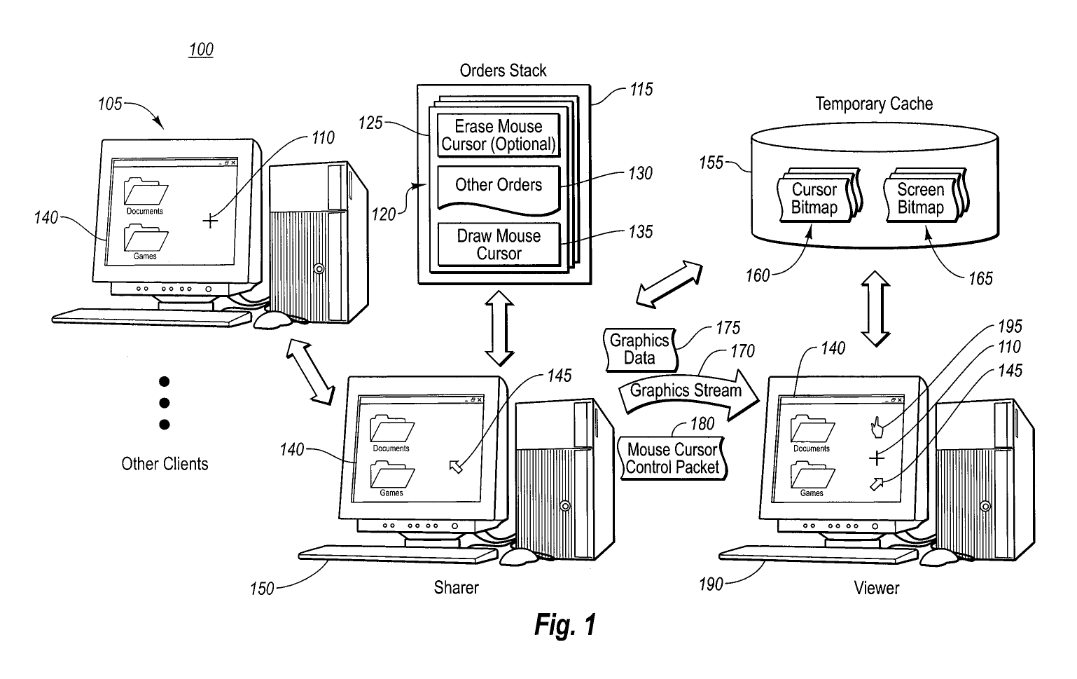

FIG. 1 illustrates a distributed system 100 configured to simultaneously display multiple cursors of a remote session in accordance with exemplary embodiments. As shown, a distributed system 100 includes a sharer computing device 150 configured to share portions of an application 140 or other resources with various clients. Note that the application may be any well known type or resource and can be executed from the sharer's 150's device or any other location.

As mentioned above, in screen sharing, remote assistance, and other similar scenarios, it is desirable for the sharer's mouse pointer 155 or cursor to be simultaneously displayed on the viewer's computing device 190. Typical remote protocols (e.g., RDP), however, only have the notion of a single mouse cursor. As such, they send mouse cursor control packets 180 for manipulating the cursor appearance (e.g., size, shape, etc.) and/or position of a viewer's 190's mouse pointer 195 when syncing it with the sharer's 150's cursor 145.

In order to support legacy clients 190, rather than modifying data instructions for the protocol that controls the viewer's 190's cursor position and/or appearance (e.g., mouse cursor control packets 180), embodiments generate a graphical representation of the mouse cursor 145. Such graphics data 175 can then be sent across a graphics stream 170 of a remote session protocol (e.g., RDP). Note that embodiments still support modification to a viewer's 190 cursor using the mouse cursor control packets 180; however, typically the viewer's 190's cursor 195 will be held constant or in a fixed shape and/or size during the remote session. In other words, the viewer 190 typically has full control over its mouse cursor 195, which will normally have a different appearance than other mouse cursors simultaneously displayed therewith for ease in identification. Nevertheless, other embodiments allow the modification of the viewer's mouse cursor 195 using cursor instructions 180, e.g., prior to holding the viewer's mouse cursor 195 constant. For example, such modification may be done to visually indicate to the viewer 190 that its cursor 195 is different than the sharer's 150's mouse cursor 145, which is used to track the local cursor 145 position. Note that in such instance, the cursor change may be to a non-standard cursor shape or some other dramatic change; however, all of these changes are optional.

As mentioned above, mouse pointers (e.g., cursor 110 shown as a cross) other than the sharer's 145 may be simultaneously displayed with the viewer's cursor 195. For example, other clients 105 cursors 110 may be part of a screen sharing or remote session (e.g., a presentation, lesson, etc.). Such cursors 110 may also simultaneously be displayed along with the viewer's cursor 195 in accordance with embodiments described herein. Accordingly, any specific cursor (e.g., sharer's cursor 145) simultaneously displayed with the viewer's 195 (as well as any appearance thereof) is used herein for illustrative purposes only and is not meant to limit the scope of embodiments herein unless otherwise explicitly claimed. Nevertheless, it should be noted that in the event that the other cursors 110 are displayed, such cursors are not the result of painting the cursor 110 on the sharer's 150's screen that is distributed as normal graphics data. Instead, they are inserted as cursor orders in the graphics stream 170 as will be described in greater detail below.

Regardless of which cursor 110, 145 is sent as a graphical representation, the viewer 190 receives such data 175 (e.g., a bitmap, primitive, sprite, or other graphical representation) across the graphic stream 170, which it can then use to simultaneously display with its own pointer 195. This graphics data 175 may be generated each time a move of the sharer's mouse cursor 145 is detected or at appropriate deltas in order to reduce bandwidth required to send multiple updates. Note that in the event that the graphical representation or graphics data 175 of the cursor 145 is sent as full screen data bitmaps, little if any erasing logic may be needed when sending updates—as will be described in greater detail below for other embodiments. In other words, screen data PDUs and other plain bitmaps are typically opaque so that it may not be necessary to erase a previous mouse pointer in cases that the updates intersect the current position of the mouse pointer. All that may be needed is to ensure that painting of the mouse pointer 145 occurs for the graphics data 175 prior to sending such across the graphic stream 170 to the client or viewer 190.

In other embodiments, however, some problems arise in screen sharing and other remote session scenarios where the sharer 150 does not include a high speed connection. In such instances, mouse updates of plain update bitmaps may take unacceptably high amounts of bandwidth and the update rate can hurt the user experience. For such scenarios, embodiments can send the sharer's 150's mouse pointer 145 in the form of rendering orders 120. For instance, updates can be stored as cursor bitmaps 160 or sprites (e.g., AND and XOR bitmaps) within a temporary 155 or other cache. Upon detecting a move (or other action) of the sharer's 150's mouse pointer 145 (or other mouse cursor 110 as the case may be), rendering orders 125, 130, 135 are inserted into the orders stack 115, which are sent as part of the normal graphics stream 170 when making the appropriate drawing and erasing functions as needed.

More specifically, the sharer 150 encoder used in remote sessions can reserve a portion of a frame buffer (on the viewer 190) for storing cursor bitmaps 160. Accordingly, updating the sharer's 150's (or other's 105's) cursor shape 145 (110) means caching 155 the bitmaps 160 (e.g., AND and XOR bitmaps) used by a cursor 145. Note that although the temporary cache 155 is shown on the viewer 190 side, this cache 155 mechanism may be on either or both sides of the distributed system 100. In other words, as one would appreciate, the cursor bitmaps 160 can first be stored in a temporary cache 155 on the sharer's 150's side. Eventually, however, the cursor bitmaps 160 will be sent as graphics data 175 in the graphics stream 170, which may then be stored on the viewer side 190 in a frame buffer. As will be described in greater detail below, update orders 120 can then (or simultaneously) be sent as part of the graphics stream 170 in rendering of the cursor 145, 110 updates on the viewer 190 display. Of course, the system is not limited to any particular type of configuration and use of temporary cache 155 (e.g., a frame buffer or other storage mechanism on either the sharer 150 or viewer 190); and therefore, any specific aesthetic layout or use thereof is for illustrative purposes only and is not meant to limit or narrow the scope of embodiments described herein.

Nevertheless, it should be noted that typically in remote session protocols (e.g., RDP) the frame buffers on the sharer 150 and viewer 190 are kept in sync. Due to the rendering of the sharer's 150's cursor 145 as orders 120 of the graphics stream 170, however, these buffers will not include identical data. More specifically, the cursor bitmaps 160 will typically not be included on the sharer's 150's frame buffer 155, since the sharer's 150's cursor 145 is not rendered as graphics data on its own screen. Nevertheless, as will be described in greater detail below, there may be instances where syncing of the two frame buffers 155 is needed—for example, as a mechanism for erasing the rendered sharer's 150 or other clients 105 cursor 110, 145.

Regardless of where or how the temporary cache 155 is used, upon detection of a needed sharer's 150's cursor 145 update (due to a move or other action or screen modification that causes the cursor 110, 145 to change in position and/or appearance), the update shape 160 with the orders or primitives used in the screen sharing or other remote session will be stored. In other words, the orders to draw mouse cursor 135 are inserted as part of the orders stack 115 typically at the end for ensuring that the pointer 145, 110 is displayed over other screen bitmaps 165 rendered using other orders 130 within the stack 115. Note that in order to draw the cursor 145, 110 on the viewer side 190, the cached 155, e.g., AND and XOR bitmaps 160 will typically be used in a quaternary raster operation—similar to a MaskBlt—to render he cursor 145, 110 to the viewer 190.

More specifically, the cursor 145, 110 can be rendered by drawing at coordinates specified by a cursor 145, 110 position and an offset of the cursor 145, 110 hotspot. Typical protocols, however, do not support quaternary raster operations, so the actual drawing of the cursor 145 may be split into two equivalent ternary raster operations. Of course, there are other mechanisms for rendering primitives or cached bitmaps 160 on the viewer's 190's display, and therefore the above use of raster operations are for illustrative purpose only and are not meant to limit or narrow the scope of embodiments unless otherwise explicitly claimed.

Note that before the mouse pointer 145 is drawn, it may be necessary to make sure that the mouse pointer 145 can be erased. Embodiments accomplish this task in various ways. For example, the cursor bitmaps 160 and other screen portions 165 may be saved (e.g., using SaveScreenBits or memblt) to an off screen cache 155 using similar operations as described in the above rendering operations. Another way may be to save the mouse pointer 145, 110, but draw the mouse pointer 145, 110 in an inverted way. If the screen content (e.g., screen bitmaps 165) were saved using an offscreen or other similar bitmap operation, erasing the mouse cursor 145 may imply restoring the screen bits 165 from temporary cache 155. For example, we can restore the screen bits by syncing the content of the sharer's 150's frame buffer with the viewer's 190's in order to render the application 140 without the cursor 145 (as previously mentioned). Alternatively, the bits may be resorted by save screen orders (e.g., RestoreSavedScreen) in the stack 115 that restore screen bitmaps 165 that are saved on the viewer 190 side.

On the other hand, if the drawing of the cursor 145 on the viewer side 190 was not saved but instead inverted (as shown in FIG. 1), cursor 145 may be drawn using a raster operation which is the reverse of the drawing operation noted above. Of course, as one would recognize, there are many various mechanisms for erasing a previous bitmap, which are also contemplated herein. Accordingly, any specific mechanism for refreshing, updating, and/or erasing the sharer's 150's (or other client's 105) cursor 145 (110) are used herein for illustrative purposes only and are note meant to limit or otherwise narrow embodiments unless explicitly claimed.

Note that the operation for the above drawing and erasing (as well as the replacement of full bitmaps as graphics data 175) can be used when a mouse pointer move or other operation is detected. In one embodiment, the mouse pointer 145 should typically be erased at the beginning of an update—as shown in order stack 115 as erase mouse cursor order 125—which will then be redrawn at the end of the order stack 115 as previously described. One problem associated with such embodiment, however, is that it might cause flickering on the viewer 190. Accordingly, another embodiment provides for detecting if an order 130 intersects a rectangle occupied by the mouse pointer 145 position. If this is the case, a mouse erase order 125 may be encoded in the order update packet followed by the mouse draw orders 135 at the end of the order update packet. In other words, the erase mouse cursor 125 at the beginning of the order stack 115 is optional. Also note that this erase 125 may not be needed if it is determined that other orders 130 fully overwrite a current mouse 145 position. Such orders 130 (including those mentioned above), however, will typically need to be opaque. If the orders 130 are transparent or the destination of the rectangle does not completely replace the mouse cursor 145 position, the cursor 145 may have to be erased as described above.

Note that the cursors instructions 180 sent over the control channel 185 may still modify portions of the viewer's mouse 195. For example, as described above, these may be used to set the viewer's mouse 195 to a fixed shape or size for the duration of the remote session. In addition, for non-legacy clients that support multiple cursor instructions 180, such mechanisms may also be employed with embodiments described herein. Nevertheless, the graphical representation or graphics data 175 of the cursor 145 for the sharer 150 or any other client 105 may be generated as described above and sent across the graphic stream 170 for display on the viewer 190.

Also note that the graphics data 175 can be a full bitmap, cursor bitmap 160, or other orders 120 or graphics data 175 as previously described. In addition note that although typically the viewer's mouse cursor 190 will be different (in shape, size, position, etc.) from a sharer's mouse cursor 145 and/or other client's mouse cursors 110, such embodiment is not is typically used for convenient purposes but is not necessary for all scenarios. Also note that in the case where there is a slow link or other mechanism that causes flickering, bitmaps may or may not be sent at each particular move operation for the cursor 145, but rather at intermediate intervals or deltas in the remote session.

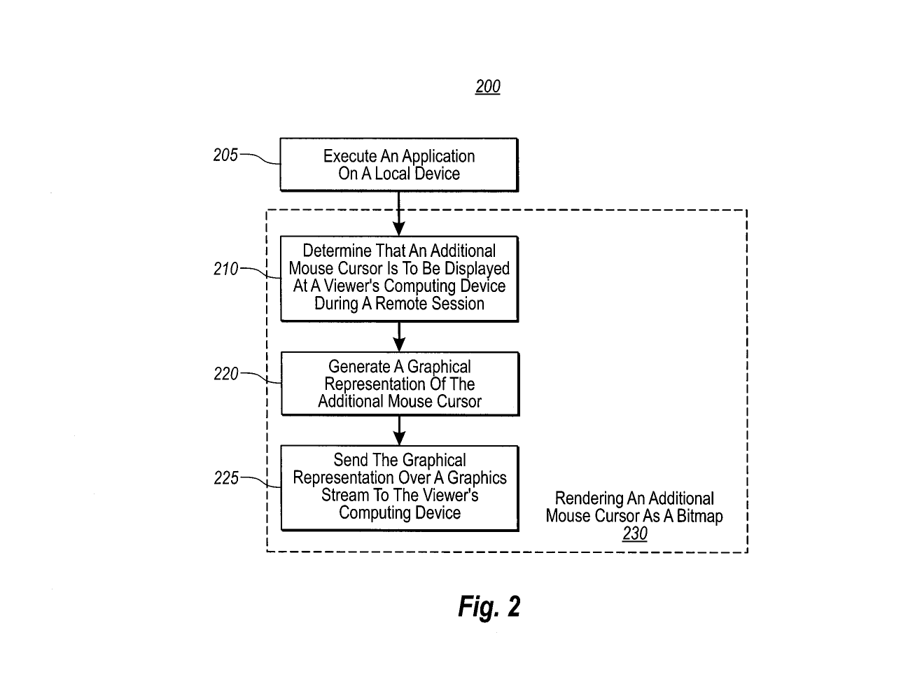

The present invention may also be described in terms of methods comprising functional steps and/or non-functional acts. The following is a description of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts in the recitation of the claims—and in the following description of the flow diagram for FIG. 2—is used to indicate the desired specific use of such terms.

As previously mentioned, FIG. 2 illustrates a flow diagram for various exemplary embodiments of the present invention. The following description of FIG. 2 will occasionally refer to corresponding elements from FIG. 1. Although reference may be made to a specific element from this Figure, such references are used for illustrative purposes only and are not meant to limit or otherwise narrow the scope of the described embodiments unless explicitly claimed.

FIG. 2 illustrates a method 200 of extending the protocol for a remote session to enable legacy clients to simultaneously display multiple cursors without having to modify data instructions for a channel of the protocol that controls the legacy client's cursor position and/or its appearance. Method 200 includes an act of executing 205 an application on a local device. For example, sharer 150 may execute an application 140, which generates graphics display for rendering at a viewer's 190's computing device during a remote session that uses a protocol configured to remote graphics display using a graphic stream 170 (e.g., RDP). Typically, such protocol sends changes for the viewer's 190 mouse cursor 195 as data instructions of a control packet 180 in order to sync the viewer's mouse cursor 195 and the local device mouse cursor (e.g., sharer cursor 145).

Accordingly, data instructions may be sent as mouse cursor control packets 180 for making an initial change to the appearance and/or position of the viewer's 190's mouse cursor 195. Note, however, that after the initial change to the viewer's 190 mouse cursor 195, usually no further data instructions 180 are used to change the viewer's 190's mouse cursor 195 in order to fix its appearance for the duration of the remote session and allow the viewer full control thereof.

Method 200 also includes a step for rendering 230 an additional mouse cursor as a bitmap. Step for 230 includes an act of determining 210 that an additional mouse cursor is to be displayed at a viewer's computing device during a remote session. For example, sharer 150 can determine that at least one additional mouse cursor 145, 110 is to be displayed at the viewer's computing device 190 during the remote session. Note that such cursor 145 may also be a cursor 110 from another client 105 or maybe the sharer's 150's own mouse cursor 145.

Based on the determination, step for 230 further includes an act of generating 220 a graphical representation of the additional mouse cursor. In other words, graphics data 175 which includes a rendering of the cursor 110, 145 may be generated. Note that such graphics data 175 may include any combination of orders 120, full or plain bitmaps, cursor bitmaps 160, screen bitmaps 165, or other data normally sent over the graphics stream 170—the form of such data typically depends on what type of data the client or viewer 190 supports. As such, step for 230 includes an act of sending 225 the graphic representation over a graphics stream to the viewer's computing device. That is, the graphics stream 170 sends the graphics data 175 including graphics representation of cursor 110, 115 to the viewers 190 display in order to simultaneously display the additional mouse cursor 110, 145 with the viewer's 190 mouse cursor 195 during the remote session.

As noted above, the graphical representation 175 of the addition mouse cursor may be a graphics order 120 (125, 130, 135) of an order stack 115, and/or a graphical bitmap (e.g., AND and XOR bitmaps 160, or full screen bitmaps). Also note that the application executed 140 maybe a remote desktop, screen sharing application, or some remote assistance program. Of course, other programs are also contemplated herein. Note that if a position of the mouse cursor 145 is changed, a second graphical representation of the mouse cursor 145 in the changed position may be generated and sent to the remote device or viewer 190 for simultaneously displaying with the viewer's mouse cursor 195.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. In a distributed computing system that utilizes a protocol that typically defines the existence of a single mouse cursor when remoting graphics of an application, a method of extending the protocol for enabling legacy clients to simultaneously display multiple cursors, without having to modify data instructions for a channel of the protocol that control the legacy client's cursor position, appearance, or both, the method comprising:
executing an application on a local device, which generates a graphics display for rendering at a viewer's computing device during a remote session that uses a protocol configured to remote the graphics display using a graphics stream, wherein the protocol typically sends changes for the viewer's mouse cursor as data instructions of a control packet in order to sync the viewer's mouse cursor and the local device's mouse cursor;
determining that at least one additional mouse cursor is to be displayed at the viewer's computing device during the remote session;
based on the determination, generating a graphical representation of the at least one additional mouse cursor; and
sending the graphical representation over the graphics stream to the viewer's computing device for rendering the at least one additional mouse cursor as a bitmap in order to simultaneously display the at least one additional mouse cursor with the viewer's mouse cursor during the remote session.

2. The method of claim 1, further comprising:
sending a data instruction as a control packet for making an initial change to the appearance, position, or both, of the viewer's mouse cursor.

3. The method of claim 2, wherein after the initial change to the viewer's mouse cursor, no further data instructions are used to change the viewer's mouse cursor in order to fix its appearance for the duration of the remote session and allow the viewer full control thereof.

4. The method of claim 1, wherein one or more graphics orders, graphics bitmaps, or both, are used as the graphical representation of the at least one additional mouse cursor for sending to the viewer's computing device.

5. The method of claim 1, wherein the application executed is one or more of a remote desktop, a screen sharing application, or remote assistance program.

6. The method of claim 1, wherein the at least one additional mouse cursor is the local device's mouse cursor, a remote device's mouse cursor different from the viewer's computing device, or both.

7. The method of claim 1, further comprising:
detecting that a position of the at least one additional mouse cursor has changed; and
based on the detection, generating a second graphical representation of the at least one additional mouse cursor in the changed position; and
sending the second representation of the at least one additional mouse cursor to the remote device for simultaneous display with the viewer's cursor.

8. The method of claim 1, wherein the protocol is remote desktop protocol (RDP).

9. In a distributed computing system that utilizes a protocol that typically defines the existence of a single mouse cursor when remoting graphics of an application, a computer program product for implementing a method of extending the protocol for enabling legacy clients to simultaneously display multiple cursors, without having to modify data instructions of the protocol that control the legacy client's cursor position, appearance, or both, the computer program product comprising one or more computer readable media having stored thereon computer executable instructions that, when executed by a processor, can cause the distributed computing system to perform the following:
execute an application on a local device, which generates a graphics display for rendering at a viewer's computing device during a remote session that uses a protocol configured to remote the graphics display using a graphics stream, wherein the protocol typically sends changes for the viewer's mouse cursor as data instructions of a control packet in order to sync the viewer's mouse cursor and the local device's mouse cursor;
determine that at least one additional mouse cursor is to be displayed at the viewer's computing device during the remote session;
based on the determination, generate a graphical representation of the at least one additional mouse cursor; and
send the graphical representation over the graphics stream to the viewer's computing device for rendering the at least one additional mouse cursor as a bitmap in order to simultaneously display the at least one additional mouse cursor with the viewer's mouse cursor during the remote session.

10. The computer program product of claim 9, further comprising computer executable instructions that, when executed by a processor, can cause the distributed system to perform the following:
send a data instruction as a control packet for making an initial change to the appearance, position, or both, of the viewer's mouse cursor.

11. The computer program product of claim 10, wherein after the initial change to the viewer's mouse cursor, no further data instructions are used to change the viewer's mouse cursor in order to fix its appearance for the duration of the remote session and allow the viewer full control thereof.

12. The computer program product of claim 9, wherein one or more graphics orders, graphics bitmaps, or both, are used as the graphical representation of the at least one additional mouse cursor for sending to the viewer's computing device.

13. The computer program product of claim 9, wherein the application executed is one or more of a remote desktop, a screen sharing application, or remote assistance program.

14. The computer program product of claim 9, wherein the at least one additional mouse cursor is the local device's mouse cursor, a remote device's mouse cursor different from the viewer's computing device, or both.

15. The computer program product of claim 9, further comprising computer executable instructions that, when executed by a processor, can cause the distributed system to perform the following:
detect that a position of the at least one additional mouse cursor has changed; and
based on the detection, generate a second graphical representation of the at least one additional mouse cursor in the changed position; and
send the second representation of the at least one additional mouse cursor to the remote device for simultaneous display with the viewer's cursor.

16. The computer program product of claim 9, wherein the protocol is remote desktop protocol (RDP).
